(19) United States
(12) Patent Application Publication
(10) Pub. No.: US 2024/0331627 A1
(43) Pub. Date: Oct. 3, 2024

(54) DRIVING METHOD FOR DISPLAY DEVICE

(71) Applicant: Japan Display Inc., Tokyo (JP)

(72) Inventors: Yukio TANAKA, Tokyo (JP); Tetsuo MORITA, Tokyo (JP); Yutaka UMEDA, Tokyo (JP)

(21) Appl. No.: 18/619,597

(22) Filed: Mar. 28, 2024

(30) Foreign Application Priority Data
Apr. 3, 2023 (JP) 2023-060195

(51) Int. Cl. G09G 3/3225

(52) U.S. Cl. CPC G09G 3/3225; G09G 2300/0842; G09G 2310/08; G09G 2320/0247; G09G 2360/16

(57) ABSTRACT

An EL display device is controlled to emit light so as to effectively reduce a flicker even when low-frequency driving is used at any frequency. In a light emission control method of the EL display device including a plurality of regularly arranged light emitting elements, one or more non-light emission periods, in which the light emitting element does not emit, are inserted in one emission cycle of the light emitting element. In a luminance change of the light emitting element at the emission cycle of T≡2π/ω, l is a largest natural number with respect to a threshold frequency ωₜₕ/2π0 to satisfy lω≤ωₜₕ, the following holds:

$${\sum }_{n = 1}^{l} {\vert {c}_{n} \vert}^{2} ≦ \frac{1}{2} {\sum }_{n = 1}^{∞} {\vert {c}_{n} \vert}^{2}$$

where n is an integer and cₙ is a complex Fourier coefficient of luminance L(t) of the light emitting element in a section 0≤t<T.

### CROSS-REFERENCE TO RELATED APPLICATION

The present application claims priority from Japanese application JP2023-060195 filed on Apr. 3, 2023, the content of which is hereby incorporated by reference into this application.

### BACKGROUND OF THE INVENTION

### 1. Field of the Invention

The present invention relates to a driving method for a display device.

### 2. Description of the Related Art

JP2017-131300A describes that the driving method of a display device including an organic EL (electroluminescence) element as a display element provides a non-light emission period in each of the periods obtained by dividing a display period of one frame into a plurality of portions, and when an input of a video signal is thinned out, extends the non-light emission period in the first frame so as to equally adjust values of light emission time×luminance in each frame, thereby inhibiting flicker and improving display quality.

### SUMMARY OF THE INVENTION

The invention disclosed in the present application has various aspects, and a summary of representative of those aspects is as follows.

(1) A driving method for a display device having a plurality of light emitting elements arranged in a matrix, where one or more non-light emission periods, in which the light emitting element does not emit, are inserted in one emission cycle of the light emitting element, in a luminance change of the light emitting element at the emission cycle of T≡2π/ω, l is a largest natural number to satisfy lω≤ωₜₕ for a given threshold frequency ωₜₕ/2π, the following holds:

$${\sum }_{n = 1}^{l} {\vert {c}_{n} \vert}^{2} ≦ \frac{1}{2} {\sum }_{n = 1}^{∞} {\vert {c}_{n} \vert}^{2}$$

where n is an integer and cₙ is a complex Fourier coefficient of luminance L(t) of the light emitting element in a section 0≤t<T.

(2) In (1), the following holds:

$${\sum }_{n = 1}^{l} {\vert {c}_{n} \vert}^{2} ≦ 0.1 {\sum }_{n = 1}^{∞} {\vert {c}_{n} \vert}^{2}$$

(3) In (1) or (2), the threshold frequency ωₜₕ/2π is 45 Hz or more and 120 Hz or less.

(4) In any one of (1) to (3), timing for inserting the non-light emission period depends on a luminance level of the light emitting element.

(5) A driving method for a display device comprising the steps of controlling the display device to operate a light emitting cycle including k (1≤k) non-light emitting periods, defining that the emission cycle of the light emitting element is T≡2π/ω, defining luminance of the light emitting element in one emission cycle (0≤t<T) when the non-light emission period is not inserted is L₀(t), defining a start time of m-th non-light emission period is tᵢₘ and an end time is t_{fm} where 1≤m≤k and 0<tᵢ₁<t_{f1}<tᵢ₂<t_{f2}< . . . <tᵢₖ<t_{fk}<T, defining the luminance L(t) of the light emitting element in one emission cycle as:

$$L ( t ) = ( \begin{matrix}0 , & {t}_{i 1} \leq t < {t}_{f 1} , {t}_{i 2} \leq t < {t}_{f 2} , … , {t}_{ik - 1} \leq t < {t}_{fk - 1} , {t}_{ik} \leq t < {t}_{fk} \\ {L}_{0} ( t ) , & otherwise\end{matrix}$$

representing L(t) by Fourier series expansion as:

$$L ( t ) = \frac{{a}_{0}}{2} + {\sum }_{n = 1}^{∞} ( {a}_{n} cos n ω t + {b}_{n} sin n ω t )$$

determining the start time tᵢₘ and the end time t_{fm} of the non-light emission period to satisfy:

$$\{ \begin{matrix}{a}_{j} < {ε}_{aj} \\ {b}_{j} < {ε}_{bj}\end{matrix} , \qquad j = 1 , 2 , … , l$$

where for a given threshold frequency ωₜₕ/2π, l is a largest natural number to satisfy lω≤ωₜₕ, j is a natural number where 1≤j≤1, and εₐⱼ and ε_{bj} are threshold values.

(6) In (5),

εₐⱼ and ε_{bj} are defined so as to satisfy:

$${\sum }_{j = 1}^{l} ( {ε}_{aj}^{2} + {ε}_{bj}^{2} ) ≦ \frac{1}{2} {\sum }_{n = 1}^{∞} ( {a}_{n}^{2} + {b}_{n}^{2} )$$

(7) In (6),

εₐⱼ and ε_{bj} are defined so as to satisfy:

$${\sum }_{j = 1}^{l} ( {ε}_{aj}^{2} + {ε}_{bj}^{2} ) ≦ 0.1 {\sum }_{n = 1}^{∞} ( {a}_{n}^{2} + {b}_{n}^{2} )$$

(8) In any one of (5) to (7), the threshold frequency ωₜₕ/2π is 45 Hz or more and 120 Hz or less.

### BRIEF DESCRIPTION OF THE DRAWINGS

FIG. 1 is a diagram exemplarily illustrating a schematic structure of an EL display device having a plurality of light emitting elements that are regularly arranged;

FIG. 2A is a diagram exemplarily illustrating an equivalent circuit of a pixel circuit of the EL display device shown in FIG. 1;

FIG. 2B is a diagram exemplarily illustrating a timing chart of each signal of the equivalent circuit of the pixel circuit of the EL display device shown in FIG. 1;

FIG. 3 is a diagram illustrating an example of changes in luminance of the light emitting element due to a hysteretic characteristic of a driving transistor;

FIG. 4 is a diagram illustrating an example of changes in luminance where one or a plurality of non-light emission periods are inserted in one light emission cycle of the light emitting element;

FIG. 5 is an example of a timing chart of inserting a non-light emission period using the equivalent circuit of the pixel circuit used in the display device shown in FIG. 2A;

FIG. 6A is a diagram showing examples of changes in luminance in one light emission cycle of the light emitting element when tᵢₘ and t_{fm} (1≤m≤k) are determined;

FIG. 6B is a diagram showing examples of changes in luminance in one light emission cycle of the light emitting element when tᵢₘ and t_{fm} (1≤m≤k) are determined;

FIG. 6C is a diagram showing examples of changes in luminance in one light emission cycle of the light emitting element when tᵢₘ and t_{fm} (1≤m≤k) are determined;

FIG. 7 is a diagram showing a power spectrum in the example of FIGS. 6A-6C;

FIG. 8A is a diagram showing another example of changes in luminance in one light emission cycle of the light emitting element when tᵢₘ and t_{fm} (1≤m≤k) are determined;

FIG. 8B is a diagram showing another example of changes in luminance in one light emission cycle of the light emitting element when tᵢₘ and t_{fm} (1≤m≤k) are determined;

FIG. 8C is a diagram showing another example of changes in luminance in one light emission cycle of the light emitting element when tᵢₘ and t_{fm} (1≤m≤k) are determined;

FIG. 9 is a diagram showing the power spectrum in the example of FIGS. 8A-8C;

FIG. 10A is a diagram showing still another example of changes in luminance in one light emission cycle of the light emitting element when tᵢₘ and t_{fm} (1≤m≤k) are determined;

FIG. 10B is a diagram showing still another example of changes in luminance in one light emission cycle of the light emitting element when tᵢₘ and t_{fm} (1≤m≤k) are determined;

FIG. 10C is a diagram showing still another example of changes in luminance in one light emission cycle of the light emitting element when tᵢₘ and t_{fm} (1≤m≤k) are determined; and

FIG. 11 is a diagram showing the power spectrum in the example of FIGS. 10A-10C.

### DETAILED DESCRIPTION OF THE INVENTION

According to the findings of the applicant, when an EL display device employs low-frequency driving to reduce power consumption, luminance changes occur in one frame due to hysteresis-characteristics of the driving transistor, and thus flicker occurs. The driving method described in JP2017-131300A does not reduce flicker at any frequency, and thus lacks flexibility in performing low-frequency driving. Further, the hysteresis characteristics of the driving transistor are not taken into consideration in the method, and thus a sufficient effect of inhibiting flicker may not be obtained.

In view of the circumstances described above, the applicant has completed the present invention. The present invention can control light emission of an EL display device to effectively reduce flicker even when low-frequency driving is used at any frequency.

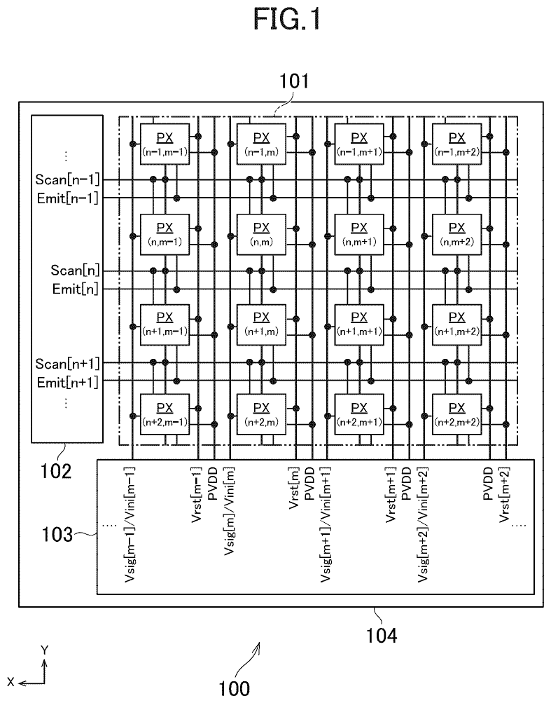

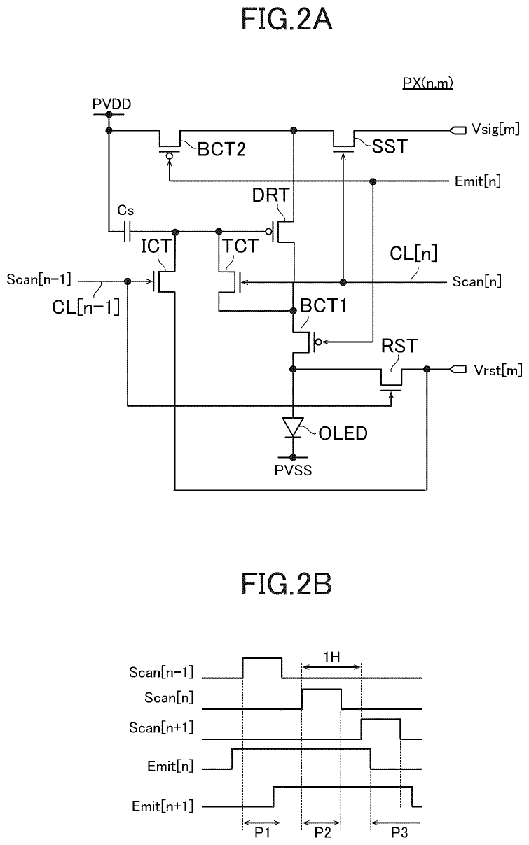

FIG. 1 exemplarily shows a diagram illustrating a schematic structure of an EL display device 100 having a plurality of light emitting elements regularly arranged capable of using a driving method, which controls light emittion, according to a preferred embodiment of the present invention, and FIG. 2A exemplarily shows a diagram illustrating an equivalent circuit of a pixel circuit of the EL display device 100, FIG. 2B exemplarily shows a timing chart of each signal thereof.

As shown in FIG. 1, the EL display device 100 includes a pixel area 101 in which a plurality of pixels PX are disposed in a row direction (X direction) and a column direction (Y direction), a scanning line driving circuit 102, and a data line driving circuit 103 on one surface (upper surface) of a substrate 104. The scanning line driving circuit 102 and the data line driving circuit 103 are positioned outside the pixel area 101. The pixel area 101 and the scanning line driving circuit 102 are disposed between the substrate 104 and a counter substrate (not shown). Wires extend from the pixel area 101 toward an end portion of the substrate 104, and are exposed at the end portion of the substrate 104 to form terminals (not shown). The terminals are connected to an external circuit via a connector (not shown), such as a flexible printed circuit (FPC). Video signals supplied from an external circuit (not shown) are supplied to the pixels PX via the scanning line driving circuit 102 and the data line driving circuit 103 to control light emitting elements of the pixels PX, whereby an image is displayed on the pixel area 101. FIG. 1 shows one scanning line driving circuit 102 provided on the left side of the pixel area 101, although two scanning line driving circuits may be provided with the pixel area 101 therebetween. Further, the scanning line driving circuit 102 and the data line driving circuit 103 may not be directly formed on the substrate 104, but a drive circuit fabricated on another substrate may be mounted on or connected to the substrate 104 or formed on a connector.

The pixels PX are provided with light emitting elements that emit different colors of light, enabling full-color display. For example, a group of three light emitting elements emitting in red, green, and blue may be arranged as a triplet. Alternatively, all the pixels PX may be provided with the light emitting elements emitting white light and perform full-color display by using color filters to extract red, green, or blue color from the respective pixels. The colors that are eventually extracted are not limited to combinations of red, green, and blue. For example, four pixels may be disposed as a set of four pixels (quartet) so as to respectively emit red, green, blue, and yellow or white light. The pixels PX may be regularly disposed in the pixel area 101 in a stripe arrangement, a delta arrangement, and a PenTile arrangement, for example.

FIG. 2A shows an equivalent circuit of a pixel circuit formed in each of the pixels PX included in the display device 100 of the present embodiment, and FIG. 2B shows a timing chart showing time changes in the signals shown in FIG. 2A.

The pixel circuit includes a light emitting element OLED, a pixel transistor SST, a reset transistor RST, a first output transistor BCT1, a second output transistor BCT2, a first switching transistor TCT, a second switching transistor ICT, and a storage capacitor Cs, as well as the driving transistor DRT, which is a p-channel transistor. In the present embodiment, the light emitting element OLED is a so-called organic EL in which an organic material is used as a light emitting layer, although the light emitting material is not limited and an inorganic material can be used.

The source of the driving transistor DRT is connected to a power supply potential PVDD via the second output transistor BCT2. The drain of the driving transistor DRT is connected to an input terminal of the light emitting element OLED via the first output transistor BCT1. An output terminal of the light emitting element OLED is connected to a ground potential PVSS.

The source of the driving transistor DRT is also connected to the video signal Vsig[m] via the pixel transistor SST. The input terminal of the light emitting element OLED is connected to the reset signal Vrst[m] via the reset transistor RST.

The first switching transistor TCT is connected between the gate and the drain of the driving transistor DRT. That is, the source of the first switching transistor TCT is connected to the gate of the driving transistor DRT, and the drain thereof is connected to the drain of the driving transistor DRT. On the other hand, the second switching transistor ICT is connected between the gate of the driving transistor DRT and the input terminal of the reset signal Vrst[m]. That is, the source of the second switching transistor ICT is connected to the gate of the driving transistor DRT, and the drain thereof is connected to the reset signal Vrst[m].

The storage capacitor Cs is connected between the gate of the driving transistor DRT and the power supply potential PVDD. That is, one terminal of the storage capacitor Cs is connected to the gate of the driving transistor DRT, and the other terminal is connected to the power supply potential PVDD.

Each of the driving transistor DRT, the pixel transistor SST, the reset transistor RST, the first output transistor BCT1, the second output transistor BCT2, the first switching transistor TCT, and the second switching transistor ICT is a field effect transistor having a channel area including silicon (e.g., polycrystalline silicon) and an oxide semiconductor. The driving transistor DRT, the first output transistor BCT1, and the second output transistor BCT2 are formed as p-channel transistors, and the pixel transistor SST, the reset transistor RST, the first switching transistor TCT, and the second switching transistor ICT are formed as n-channel transistors.

A scanning signal Scan[n] is supplied to the gate of the first switching transistor TCT via a control line CL[n]. The scanning signal Scan[n] is supplied to each pixel PX by the scanning line driving circuit 102, and is also supplied to the gate of the pixel transistor SST. A scanning signal Scan[n−1] corresponding to the pixel PX positioned in n−1 row is supplied to each gate of the second switching transistor ICT and the reset transistor RST via the control line CL[n−1]. An emit signal Emit[n] is commonly supplied to the gates of the first output transistor BCT1 and the second output transistor BCT2. The emit signal Emit[n] is also supplied by the scanning line driving circuit 102.

As can be seen from FIG. 2B, the scanning signal Scan[n] is sequentially pulse-activated from n=1 to n=N with an interval of a horizontal scanning period H. Each activation period is shorter than a time length of the horizontal scanning period H. When focusing on the pixel PX (n, m), the scanning signal Scan[n−1] is first activated, which turns the second switching transistor ICT and the reset transistor RST to on-state (reset period P1). At this time, the scanning signal Scan[n] is in a deactivated state, and thus both the first switching transistor TCT and the pixel transistor SST are in an off-state. Further, the emit signal Emit[n] is activated prior to the scanning signal Scan[n−1], and remains active until u the scanning signal Scan[n+1] is activated. As such, the first output transistor BCT1 and the second output transistor BCT2 are also in the off-state in the reset period P1.

As described above, only the second switching transistor ICT and the reset transistor RST are turned on in the reset period P1, and the reset signal Vrst[m] is supplied to the gate of the driving transistor DRT. This resets the potential of the gate (gate potential) of the driving transistor DRT to Vrst[m]. Further, the potential difference between the terminals of the storage capacitor Cs is reset to PVDD-Vrst[m].

Subsequently, when the scanning signal Scan[n] is activated, the first switching transistor TCT and the pixel transistor SST are thereby turned on (writing period P2). The scanning signal Scan[n−1] is deactivated and thus the second switching transistor ICT and the reset transistor RST are turned off, and the emit signal Emit[n] is continuously activated. As such, the first output transistor BCT1 and the second output transistor BCT2 are turned off.

In the writing period P2, the video signal Vsig[m] is supplied to the source of the driving transistor DRT, and the potentials of the gate and the drain of the driving transistor DRT each become Vsig[m]−Vth (n, m). Vth (n, m) is a threshold voltage of the driving transistor DRT of the pixel PX (n, m). At this time, the potential difference between the terminals of the storage capacitor Cs is PVDD−(Vsig[m]−Vth (n, m)).

When the emit signal Emit[n] is deactivated, the first output transistor BCT1 and the second output transistor BCT2 are turned on (output period P3). The pixel transistor SST, the reset transistor RST, the first switching transistor TCT, and the second switching transistor ICT are turned off. With this operation, the gate potential of the driving transistor DRT becomes substantially the same as Vsig[m], and the influence of Vth (n, m) is canceled from the gate potential of the driving transistor DRT. As such, intensity of a drain current of the driving transistor DRT becomes a value corresponding to Vsig[m], allowing the light emitting element OLED to emit light at an intensity corresponding to Vsig[m]. With this operation, light is emitted at the intensity corresponding to the video signal Vsig[m].

In the pixel PX (n+1, m) located in the next row of the pixel PX (n, m), the gate potential of the driving transistor DRT is reset in the writing period P2 of the pixel PX (n, m). Specifically, the scanning signal Scan[n] is activated in the writing period P2 of the pixel PX (n, m), and the second switching transistor ICT and the reset transistor RST in the pixel PX (n+1, m) are turned on. The emit signal Emit[n+1] of the pixel PX (n+1, m) is activated in the reset period P1 of the pixel PX (n, m), and the first output transistor BCT1 and the second output transistor BCT2 of the pixel PX (n+1, m) are thereby maintained in the off-state. In this manner, the gate potential of the driving transistor DRT of the pixel PX (n+1, m) is reset to Vrst[m], and the potential difference between the terminals of the storage capacitor Cs is reset to PVDD−Vrst[m].

Prior to the output period P3 of the pixel PX (n, m), the scanning signal Scan[n] is deactivated, and the scanning signal Scan[n+1] is subsequently activated. With this, the second switching transistor ICT and the reset transistor RST of the pixel PX (n+1, m) are turned off, while the first switching transistor ICT and the pixel transistor SST are turned on, and the writing of the pixel PX (n+1, m) is started. At this time, the video signal Vsig[m] is supplied to the source of the driving transistor DRT in the pixel PX (n+1, m). The potential of the gate and the drain of the driving transistor DRT becomes Vsig[m]−Vth (n+1, m) and the potential difference between the terminals of the storage capacitor Cs becomes PVDD−(Vsig[m]−Vth (n+1, m)). Vth (n+1, m) is a threshold voltage of the driving transistor DRT of the pixel PX (n+1, m). With these operations, the pixel circuit PX (n+1, m) is written in the output period P3 of the pixel PX (n, m).

The scanning signal Scan[1+1] is then deactivated and the emit signal Emit[n+1] is also deactivated. With this, the first switching transistor TCT and the pixel transistor SST are turned off and the first output transistor BCT1 and the second output transistor BCT2 are turned on in the pixel PX (n+1, m), and the output period of the pixel PX (n+1, m) is started. The gate potential of the driving transistor DRT of the pixel PX (n+1, m) becomes the same as Vsig[m] and the influence of the threshold voltage is cancelled. The drain current corresponding to Vsig[m] is supplied to the light emitting element OLED of the pixel PX (n+1, m) via the driving transistor DRT.

As described above, the driving transistor DRT controls the current of the light emitting element OLED to emit light with an intensity corresponding to the video signal Vsig[m]. This means that the change in luminance of the light emitting element OLED depends on the temporal change of the drain current from the driving transistor DRT. If the driving transistor DRT outputs a drain current having the ideal characteristic, that is, of being time-independent and dependent only on the gate potential, the luminance of the light emitting element OLED is considered to be constant while the video signal Vsig[m] is unchanged. In reality, however, the driving transistor DRT has hysteresis characteristics, and thus the drain current is not constant within one emission cycle (vertical scanning period), and the luminance of the light emitting element OLED changes accordingly.

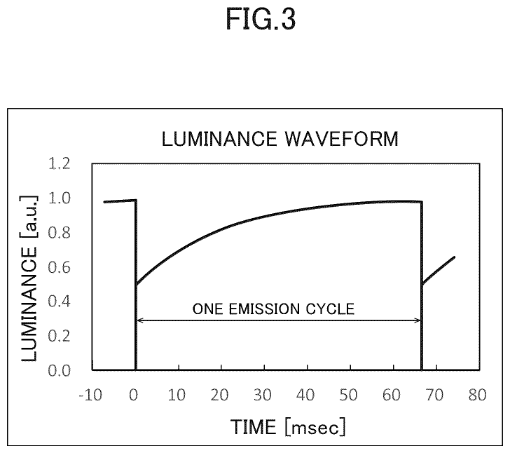

FIG. 3 is a diagram illustrating an example of change in luminance of the light emitting element OLED due to the hysteretic characteristic of the driving transistor DRT. FIG. 3 shows an example of low-frequency driving of one emission cycle about 66.7 msec, that is, emission frequency of 15 Hz.

As can be read from the luminance waveform shown in FIG. 3, the current applied to the light emitting element OLED is low and the emission luminance is also low immediately after the writing of the video signal Vsig[m] (at the time point of 0 msec). After that, the current is increased over time and the emission luminance of the light emitting element OLED is also increased to be saturated to the luminance corresponding to the set value. In this manner, the emission luminance of the light emitting element OLED differs between the beginning and the end of one emission cycle.

At this time, if the emission frequency is higher than or equal to the human flicker-fusion frequency (generally 70 Hz to 100 Hz), e.g., 90 Hz or 120 Hz, the flicker caused by the change in the emission luminance of the light emitting element OLED is not recognized by the human eye, and the images are displayed smoothly. However, if the emission luminance is changed at the frequency clearly lower than the flicker-fusion frequency of the human, such as 15 Hz in the example of FIG. 3, the images appear to flicker to the human eye, and the display quality of the display device 100 thus deteriorates.

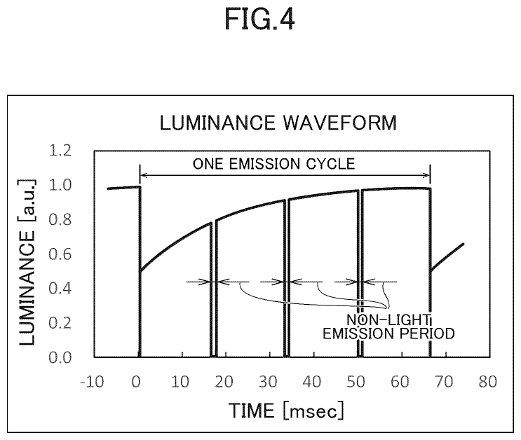

Flickering during the low-frequency driving of the display device 100 is caused by the low-frequency components of the change in the emission luminance of the light emitting element OLED, specifically, the components of the frequency lower than the flicker-fusion frequency of a human. In this regard, as shown in FIG. 4, one or a plurality of non-light emission periods are inserted in one light emission cycle of the light emitting element OLED. That is, during the light emission of the light emitting element OLED, a period in which the light emitting element OLED is not turned on and is displayed in black is inserted for a short period of time that cannot be recognized by the human eye.

Even if such a non-light emission period is simply provided at regular intervals and for a certain period of time, the low-frequency components of the luminance change of the light emitting element OLED are not largely changed. As such, it is considered that the flicker during the low-frequency driving of the display device 100 cannot be sufficiently reduced. However, the applicant has found that, if the inserting timing of the non-light emission period, the time of the respective non-light emission periods, and the number of non-light emission periods to be inserted are appropriately designed, the low-frequency components of the luminance change of the light emitting element OLED can be reduced and the flicker during the low-frequency driving of the display device 100 can be reduced. In the following, a method of inserting the non-light emission period and the design of the non-light emission period will be described in detail.

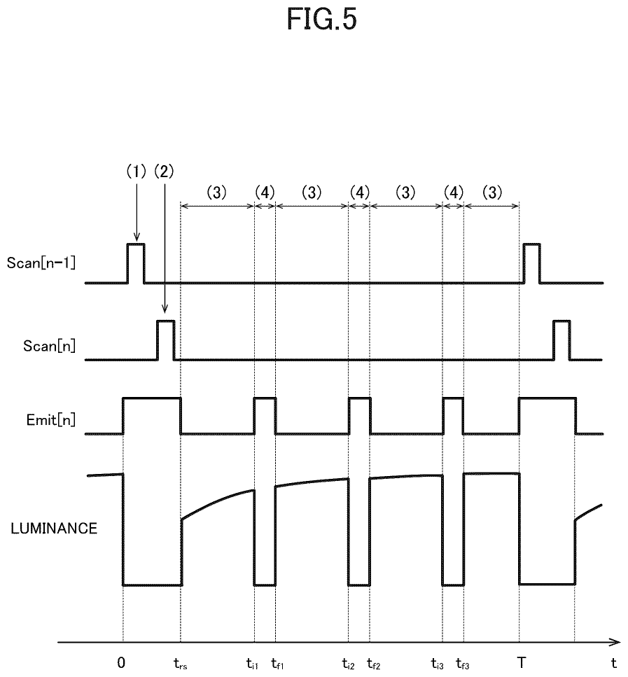

FIG. 5 is an example of a timing chart of inserting a non-light emission period using an equivalent circuit of the pixel circuit used in the display device 100 shown in FIG. 2A. The time indicated by the horizontal axis in FIG. 5 shows the ratio adjusted for convenience of illustration, and the light emitting element OLED is not necessarily driven in accordance with the ratio as illustrated.

When one light emission cycle of the light emitting element OLED is 0≤t<T, (1) in FIG. 5 is a reset period P1 shown in FIG. 2B, in which the second switching transistor ICT and the reset transistor RST are turned on and the potential difference between the terminals of the storage capacitor Cs is reset to PVDD-Vrst[m] as an initial value. The following (2) is a writing period P2 shown in FIG. 2B, in which the first switching transistor TCT and the pixel transistor SST are turned on, and the potential difference between the terminals of the storage capacitor Cs is PVDD−(Vsig[m]−Vth (n, m)).

In the period of 0≤t<tᵣₙ including (1) and (2), Emit[n] is turned on, and thus the first output transistor BCT1 and the second output transistor BCT2 are turned off and the light emitting element OLED remains in the non-light emitting state.

In the period of tᵣₛ≤t<T, the period indicated by (3) is the output period P3 shown in FIG. 2B, in which the first output transistor BCT1 and the second output transistor BCT2 are turned on and the light emitting element OLED emits light with an intensity corresponding to Vsig[m]. However, when looking at the entire light emission cycle, the luminance is low at the beginning as shown mainly due to the influence of the hysteresis-characteristic of the driving transistor DRT caused by the stress in the reset-period P1 of (1). As time passes, the luminance increases and has a saturated luminance curve.

In the period shown in (4), that is, in the example of FIG. 5, three periods of tᵢ₁≤t<t_{f1}, tᵢ₂≤t<t_{f2} and tᵢ₃≤t<t_{f3} are non-light emission periods. In the non-light emission period, Emit[n] is temporarily turned on, the first output transistor BCT1 and the second output transistor BCT2 are turned off, and the light emitting element OLED is in the non-light emitting state. When the non-light emission period ends, Emit[n] is turned off again, the first output transistor BCT1 and the second output transistor BCT2 are turned on, and the light emitting element OLED emits light again with an intensity corresponding to Vsig[m] defined by the potential difference between the terminals of the storage capacitor Cs. At this time, the on or off state of Emit[n] does not influence the driving transistor DRT, and thus the luminance curve caused by the hysteretic characteristic of the driving transistor DRT maintains the shape before the insertion of the non-emission period.

As described above, in one light emission cycle of the light emitting element OLED, Emit[n] is controlled to be turned on or off at an appropriate timing, whereby the non-light emission period can be inserted. The number of non-light emission periods inserted in one light emission cycle is not limited to three as shown in FIG. 5, and may be four or more, or one or two.

In general, the horizontal scanning period H of the display device 100 is sufficiently short relative to the one light emission cycle T, that is, the vertical scanning period, of the light emitting element OLED. As such, the period of 0≤t<tᵣₙ including (1) and (2) in FIG. 5 can be almost ignored and treated as tᵣₛ≈0.

Assume that the luminance of the light emitting element OLED in one light emission cycle T in which the non-light emission period is not provided is L₀(t) (0≤t<T;T≡2π/ω), and the non-light emission period is inserted k times (1≤k) in one light emission period. The start time of the m-th non-light emission period is tᵢₘ and the end time is t_{fm} where 1≤m≤k and 0<tᵢ₁<t_{f1}<tᵢ₂< . . . <tᵢₖ<t_{fk}<T, the luminance L(t) in one light emission cycle of the light emitting element OLED can be written as follows:

$$L ( t ) = ( \begin{matrix}0 , & {t}_{i 1} \leq t < {t}_{f 1} , {t}_{i 2} \leq t < {t}_{f 2} , … , {t}_{ik - 1} \leq t < {t}_{fk - 1} , {t}_{ik} \leq t < {t}_{fk} \\ {L}_{0} ( t ) , & otherwise\end{matrix} \qquad ( 1 )$$

L(t) can be represented by Fourier series expansion as follows:

$$L ( t ) = \frac{{a}_{0}}{2} + {\sum }_{n = 1}^{∞} ( {a}_{n} cos n ω t + {b}_{n} sin n ω t ) \qquad ( 2 )$$

At this time, coefficients of the series are as follows:

$$\begin{matrix}{a}_{n} = \frac{2}{T} {\int }_{0}^{T} L ( t ) cos ( n ω t ) dt \\ {b}_{n} = \frac{2}{T} {\int }_{0}^{T} L ( t ) sin ( n ω t ) dt\end{matrix}$$

The coefficients aₙ and bₙ are functions of tᵢₘ and t_{fm} (1≤m≤k) as follows if L₀(t) is given based on the formula (1).

$${a}_{n} ( {t}_{i 1} , {t}_{f 1} , {t}_{i 2} , {t}_{f 2} , … , {t}_{ik} , {t}_{fk} ) = \frac{2}{T} {\int }_{0}^{{t}_{i 1}} {L}_{0} ( t ) cos ( n ω t ) dt + \frac{2}{T} {\int }_{{t}_{f 1}}^{{t}_{i 2}} {L}_{0} ( t ) cos ( n ω t ) dt + \frac{2}{T} {\int }_{{t}_{f 2}}^{{t}_{i 3}} {L}_{0} ( t ) cos ( n ω t ) dt + … + \frac{2}{T} {\int }_{{t}_{fk - 1}}^{{t}_{ik}} {L}_{0} ( t ) cos ( n ω t ) dt + \frac{2}{T} {\int }_{{t}_{fk}}^{T} {L}_{0} ( t ) cos ( n ω t ) dt \qquad ( 3 )$$

$${b}_{n} ( {t}_{i 1} , {t}_{f 1} , {t}_{i 2} , {t}_{f 2} , … , {t}_{ik} , {t}_{fk} ) = \frac{2}{T} {\int }_{0}^{{t}_{i 1}} {L}_{0} ( t ) sin ( n ω t ) dt + \frac{2}{T} {\int }_{{t}_{f 1}}^{{t}_{i 2}} {L}_{0} ( t ) sin ( n ω t ) dt + \frac{2}{T} {\int }_{{t}_{f 2}}^{{t}_{i 3}} {L}_{0} ( t ) sin ( n ω t ) dt + … + \frac{2}{T} {\int }_{{t}_{fk - 1}}^{{t}_{ik}} {L}_{0} ( t ) sin ( n ω t ) dt + \frac{2}{T} {\int }_{{t}_{fk}}^{T} {L}_{0} ( t ) sin ( n ω t ) dt$$

As described above, components of a frequency lower than the flicker-fusion frequency of the human cause the deterioration of display quality of the display device 100 due to flickering. Accordingly, if the low-frequency components can be reduced, flicker can be inhibited. As such, it is considered that a threshold frequency ωₜₕ/2π is defined to subtract frequency components below the threshold frequency ωₜₕ. In this regard, the threshold frequency ωₜₕ/2π is determined in consideration of the human flicker fusing frequency, and is preferably 45 Hz or more and 120 Hz or less.

Assume that l is the largest natural number to satisfy lω≤ωₜₕ for the threshold frequency ωₜₕ/2π. For example, as shown in FIG. 4, when the emission frequency ω/2π(≡1/T) of light emitting element OLED is 15 Hz, 1 equals to 3 when the threshold frequency ωₜₕ/2π is set to 45 Hz. The low-frequency component L_{low} (t) of the luminance L(t) of light emitting element OLED, which are equal to or less than the threshold frequency ωₜₕ/2π, is as follows. Here, the constant term including a₀ does not cause flicker and thus does not need to be considered.

$${L}_{low} ( t ) = {\sum }_{n = 1}^{l} ( {a}_{n} cos n ω t + {b}_{n} sin n ω t )$$

Accordingly, if aₙ and bₙ, which are coefficients of the series for n=1, 2, . . . , l can be sufficiently small, flickering of the display device 100 is reduced. As such, when the natural number j is 1≤j≤l, and sufficiently small threshold values εₐⱼ and ε_{bj} are given for respective aⱼ and bⱼ, tᵢₘ and t_{fm} (1≤m≤k) are determined by solving the formula (3) to satisfy the following formula:

$$\begin{matrix}\{ \begin{matrix}{a}_{j} < {ε}_{aj} \\ {b}_{j} < {ε}_{bj}\end{matrix} , & j = 1 , 2 , … , l\end{matrix} \qquad ( 4 )$$

And, the non-light emission period can be thereby set specifically during one light emission cycle of the light emitting element OLED. This can reduce flickering during the low-frequency driving of the display device 100.

The formula (3) is a nonlinear simultaneous equation and is usually difficult to solve analytically. As such, tᵢₘ and t_{fm} (1≤m≤k) may be obtained by any numerical solution method using a calculator. Specifically, any initial value, such as a value to insert the non-light emission period at regular intervals for a certain period of time, may be given to tᵢₘ and t_{fm}, and iterative calculation is performed using the Newtonian method to update the values of tᵢₘ and t_{fm}. The values of tᵢₘ and t_{fm} at the time when the formula (4) is satisfied may be used as solutions. In the following, to update tᵢₘ and t_{fm} using the numerical solution until the formula (4) is satisfied is referred to as “to optimize the non-emission period.”

At this time, the threshold values εₐⱼ and ε_{bj} indicated in formula (4) need to be determined to sufficiently reduce flicker of the display device 100. It is considered that whether the flicker of the display device 100 is distracting when viewed by the human eye depends on the ratio of light emitting energy of the low-frequency components L_{low}(t) of light emission of the light emitting element OLED to the total light emitting energy in one light emission cycle of the light emitting element OLED. That is, it is considered that, when the ratio of the energy pertaining to the low-frequency components L_{low}(t) to all the light emitting energies in one light emission cycle of the light emitting element OLED is lower, the less flickering is recognized. In this regard, when the emission energy of the light emitting element OLED is set to E(L) as a function of the luminance waveform, the sum of squares of the Fourier series coefficients aₙ and bₙ have the dimension of the energy, and the following holds:

$$\begin{matrix}E ( L ( t ) ) ∝ {\sum }_{n = 1}^{∞} ( {a}_{n}^{2} + {b}_{n}^{2} ) \\ E ( {L}_{low} ( t ) ) ∝ {\sum }_{n = 1}^{l} ( {a}_{n}^{2} + {b}_{n}^{2} ) ≦ {\sum }_{j = 1}^{l} ( {ε}_{aj}^{2} + {ε}_{bj}^{2} )\end{matrix}$$

As such, for example, to determine tᵢₘ and t_{fm} (1≤m≤k) such that the energy of the low-frequency components L_{low}(t) is 50% or less of the total emission energy, threshold values εₐⱼ, ε_{bj} may be determined so that the following holds:

$$E ( {L}_{low} ( t ) ) ≦ \frac{1}{2} E ( {L}_{0} ( t ) )$$

that is:

$${{\sum }^{l}}_{j = 1} ( {ε}_{aj}^{2} + {ε}_{bj}^{2} ) ≦ \frac{1}{2} {\sum }_{n = 1}^{∞} ( {a}_{n}^{2} + {b}_{n}^{2} ) \qquad ( 5 )$$

Here, the value on the right side of the formula (5) can be easily obtained from the following formula by Parseval's identity:

$${\sum }_{n = 4}^{∞} ( {a}_{n}^{2} + {b}_{n}^{2} ) = \frac{ω}{π} {\int }_{0}^{r} {[ {L}_{0} ( t ) ]}^{2} dt - \frac{{a}_{0}}{2}$$

Alternatively, for example, to determine tᵢₘ and t_{fm} (1≤m≤k) such that the energy of the low-frequency component L_{low} (t) is 10% or less of the total emission energy, threshold values εₐⱼ and ε_{bj} may be similarly determined so that the following holds:

$${{\sum }^{l}}_{j = 1} ( {ε}_{aj}^{2} + {ε}_{bj}^{2} ) ≦ 0.1 {\sum }_{n = 1}^{∞} ( {a}_{n}^{2} + {b}_{n}^{2} ) \qquad ( 6 )$$

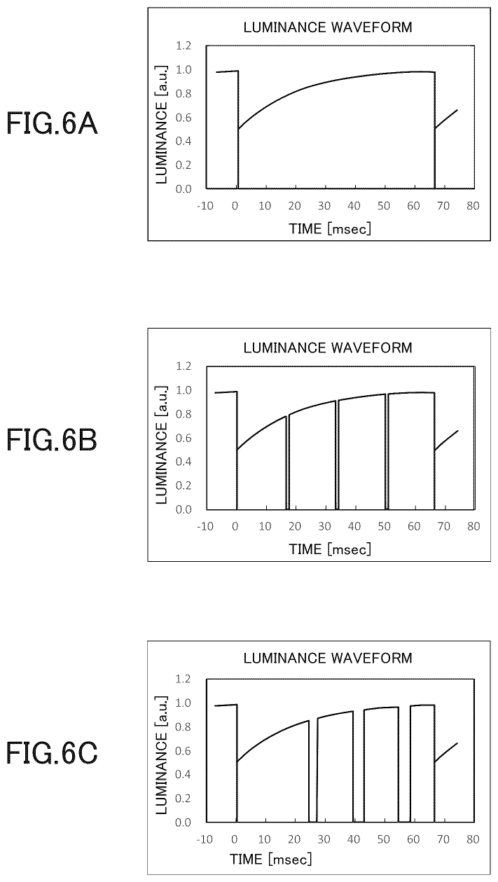

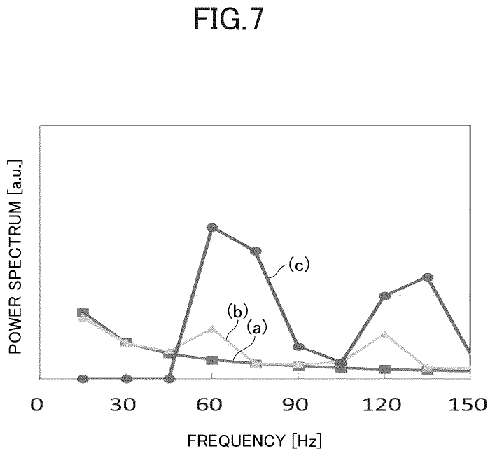

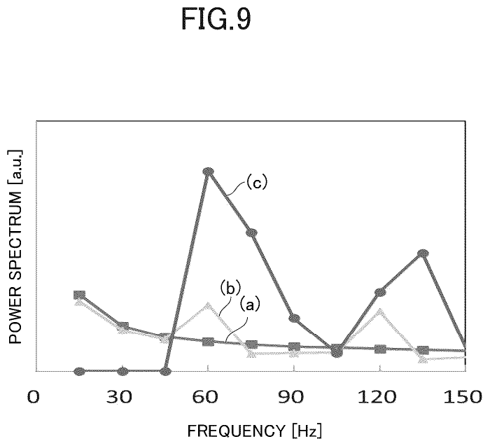

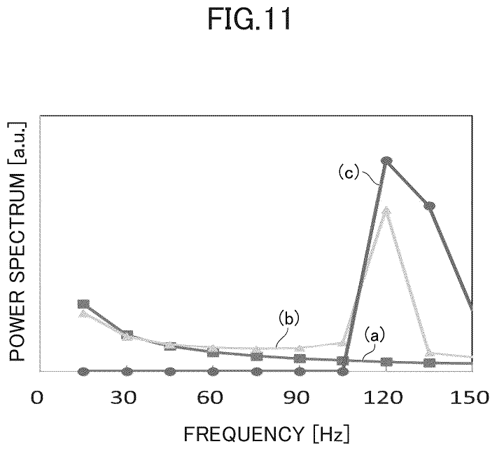

FIGS. 6A to 6C are diagrams showing examples of changes in luminance in one light emission cycle T of the light emitting element OLED when tᵢₘ and t_{fm} (1≤m≤k) are determined using the threshold values εₐⱼ and ε_{bj} determined by the formula (6). FIG. 7 is a diagram showing the power spectrum in the examples of FIGS. 6A to 6C. FIGS. 6A and (a) in FIG. 7 indicate a case where the non-light emission period is not inserted, FIGS. 6B and (b) in FIG. 7 indicate a case before the non-light emission period is optimized, and FIGS. 6C and (c) in FIG. 7 indicate a case after the non-light emission period is optimized. The examples of FIGS. 6A to 6C and 7 indicate a case in which the non-light emission period is inserted three times in one light emission cycle T of the light emitting element OLED and the threshold frequency ωₜₕ/2π is 45 Hz. The emission cycle of the light emitting element OLED is a driving frequency of as low as 15 Hz. The luminance L(t) is a periodic function of the frequency ω/2π, and thus the power spectrum appears as a line spectrum for every nω/2π (n=1, 2, . . . ). In FIG. 7, the values of the line spectrum are illustrated as a curve connected by a straight line. The same applies to FIGS. 9 and 11.

As can be easily understood from FIG. 7, in the case (a) in which the non-emission period is not inserted, it is considered that flicker occurs due to a large number of low-frequency components equal to or below 45 Hz in the power spectrum. In the case (b) in which the non-light emission periods are inserted without being optimized, the components of 60 Hz and 120 Hz of the power spectrum increase due to the inserted non-light emission periods, although the components of the low-frequency equal to or below 45 Hz are not greatly changed. As such, it is also considered that flicker occurs. On the other hand, in the case (c) in which the non-emission periods are optimized as described above, the components of the low-frequency equal to or below 45 Hz of the power spectrum are inhibited and almost absent, and the emission of the light emitting element OLED is constituted by virtually only the components of 60 Hz or more. Accordingly, in the case (c), it is considered that flicker is hardly felt in the human eye. As can be seen from FIG. 6C, the timing and the time length for inserting the respective non-light emission periods are different and optimized in the case (c).

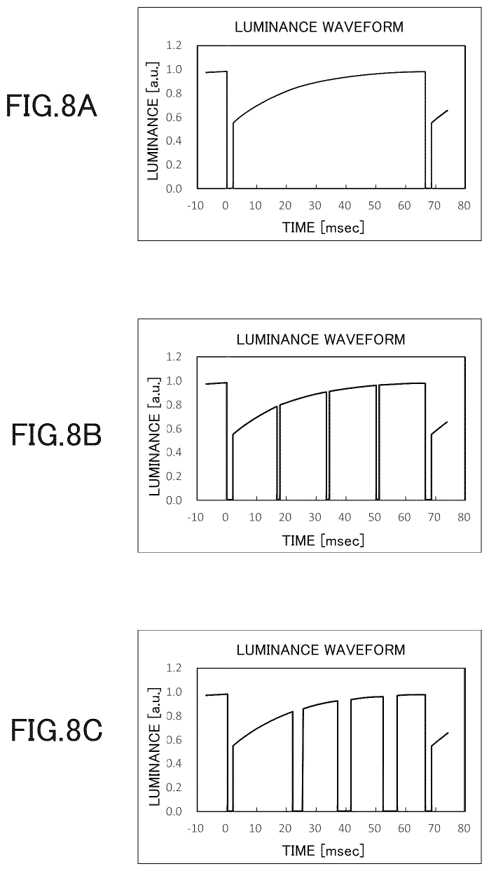

FIGS. 8A to 8C are diagrams showing another example of changes in luminance in one light emission cycle T of the light emitting element OLED when tᵢₘ and t_{fm} (1≤m≤k) are determined using the threshold values εₐⱼ and ε_{bj} determined by the formula (6). FIG. 9 is a diagram showing the power spectrum in the examples of FIGS. 8A to 8C. FIGS. 8A and (a) in FIG. 9 indicate a case where the non-light emission period is not inserted, FIGS. 8B and (b) in FIG. 9 indicate a case before the non-light emission period is optimized, and FIGS. 8C and (c) in FIG. 9 indicate a case after the non-light emission period is optimized. Similarly to the examples of FIGS. 6A to 6C and 7, the examples of FIGS. 8A to 8C and 9 indicate that the non-light emission period is inserted three times during one light emission cycle T of the light emitting element OLED, the threshold frequency ωₜₕ/2π is 45 Hz, and the light emission period of the light emitting element OLED is 15 Hz. In the examples of FIGS. 8A to 8C and 9, a black display period is provided at the beginning or the end (in this example, beginning) of one light emission cycle T of the light emitting element OLED due for convenience of designing the pixel circuit, for example.

In this case as well, in the above-described procedure, the luminance L₀(t) of the light emitting element OLED in one light emission cycle T in the case where the non-light emission period is not provided is given as including the black display period, and the non-light emission period may be similarly optimized. As shown in FIG. 9, as in the previous example, in the case (a) where the non-light emission period is not inserted and the case (b) where the non-light emission period is inserted without being optimized, the power spectrum includes many low-frequency components equal to or below 45 Hz and flicker is considered to occur. In contrast, in the case (c) where the non-light emission period is optimized as described above, the low-frequency components equal to or below 45 Hz in the power spectrum are inhibited and flicker is hardly felt in the human eye. As can be seen from FIG. 8C, the non-light emission period in the case of (c) in this example shows that the insertion timing and the time length are different from those indicated in FIG. 6C, and it can be seen that the insertion timing and the time length of the optimized non-light emission periods are different according to the waveform of the luminance L₀(t).

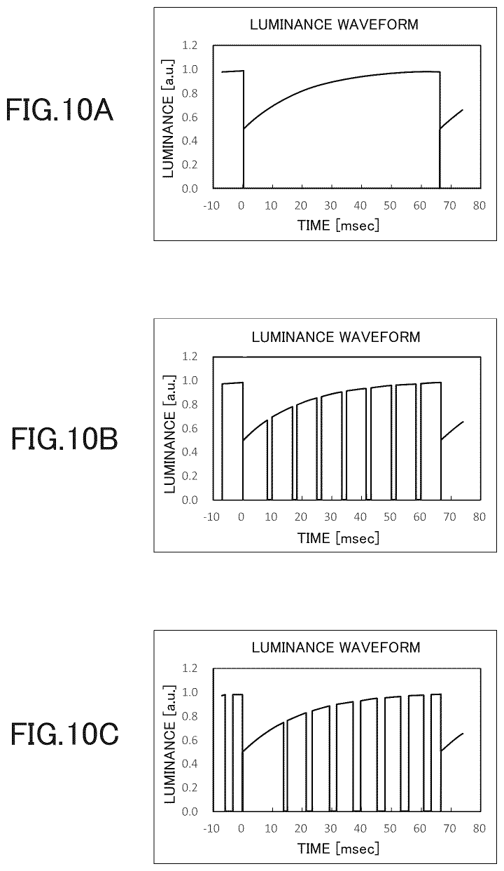

FIGS. 10A to 10C are diagrams showing still another example of changes in luminance in one light emission cycle T of the light emitting element OLED when tᵢₘ and t_{fm} (1≤m≤k) are determined using the threshold values εₐⱼ and ε_{bj} determined by the formula (6). FIG. 11 is a diagram showing the power spectrum in the examples of FIGS. 10A to 10C. FIGS. 10A and (a) in FIG. 11 indicate a case where the non-light emission period is not inserted, FIGS. 10B and (b) in FIG. 11 indicate a case before the non-light emission period is optimized, and FIGS. 10C and (c) in FIG. 11 indicate a case after the non-light emission period is optimized. The luminance waveforms in the examples of FIGS. 10A to 10C and 11 are the same as those shown in FIGS. 6A to 6C and 7, and the emission cycle of the light emitting element OLED is 15 Hz. In this example, assume that the non-emission period is inserted seven times, and the threshold frequency ωₜₕ/2π is 110 Hz.

As shown in (c) of FIG. 11, in this example, the low-frequency components equal to or below 105 Hz of the power spectrum are inhibited, and it is considered that flicker is less likely to be felt in the human eye than in the previous two examples. In this example, there is no light emission of the frequency components corresponding to 110 Hz, which is the threshold frequency, and 105 Hz is the largest frequency component closest to the threshold frequency. As can be seen from FIGS. 10B and (b) in FIG. 11, even if the non-light emission period is inserted many times, simply inserting the non-light emission period at a fixed cycle or time cannot inhibit the low-frequency component. In this regard, as shown in FIGS. 10C and (c) in FIG. 11, if the non-light emission period is optimized, the low-frequency component equal to or below 105 Hz of the power spectrum can be sufficiently inhibited.

In order to inhibit flicker for a higher threshold frequency, more non-light emission periods may need to be inserted. The formula (4) is formally a simultaneous inequality having 21 expressions. If there are 21 or more tᵢₘ and t_{fm} (1≤m≤k) as independent variables, the simultaneous inequality can be solved significantly, and thus the number of insertions k of the non-light emission period may be determined so that k≥l. Although the power spectrum of the low-frequency components below the threshold frequency may be sufficiently inhibited even if k<l depending on the waveform of the luminance L₀(t) in one light emission cycle T of the light emitting element OLED, such a solution is not necessarily guaranteed.

From the foregoing, it can be seen that tᵢₘ and t_{fm} that can inhibit flicker with respect to a given threshold frequency are determined according to the shape of the luminance L₀(t). As such, if the shape of the luminance L(t) of the light emitting element OLED is linear with respect to the luminance level of the light emission, tᵢₘ and t_{fm} may be uniquely determined regardless of the luminance level. If the shape of the luminance L(t) changes nonlinearly according to the luminance level, tᵢₘ and t_{fm} that differ from each other may be determined based on the shape of the changed luminance L(t) for each luminance level. In this case, the insertion timing of the non-light emission period differs depending on the luminance level of the light emitting element OLED.

As described above, the display device 100 in which the non-light emission period is inserted in one light emission cycle of the light emitting element OLED is considered to have the following characteristics of the light emission control method. That is, if the luminance at the one emission cycle T≡2π/ω is measured and determined to be L(t) (0≤t<T), L(t) can be expanded into the Fourier series as follows:

$$L ( t ) = {\sum }_{n = 1}^{∞} {c}_{n} {e}^{in ω t}$$

Here, n is an integer, and cₙ is a complex Fourier coefficient, and the following holds for the coefficients aₙ and bₙ of the series shown in the formula (2):

$${\vert {c}_{n} \vert}^{2} = \frac{{a}_{n}^{2} + {b}_{n}^{2}}{4}$$

With this in mind, referring to the formula (5), the following holds as l being the largest natural number satisfying lω≤ωₜₕ for a given threshold-frequency ωₜₕ/2π:

$${{\sum }^{l}}_{n = 1} {\vert {c}_{n} \vert}^{2} ≦ \frac{1}{2} {\sum }_{n = 1}^{∞} {\vert {c}_{n} \vert}^{2} \qquad ( 7 )$$

Alternatively, referring to the formula (6), similarly the following holds:

$${\sum }_{n = 1}^{l} {\vert {c}_{n} \vert}^{2} ≦ 0.1 {\sum }_{n = 1}^{∞} {\vert {c}_{n} \vert}^{2} \qquad ( 8 )$$

Here, |cₙ|² has a dimension of energy. When the luminance change of the light emitting element OLED in the display device 100 is measured and the power spectrum P (f) of L(t) is measured by a typical spectrum analyzer, the power spectrum P (f) appears as a line spectrum for each frequency nω/2π (n=1, 2, . . . ) and holds the following relationship to |cₙ|²:

$$P ( \frac{n ω}{2 π} ) ∝ {\vert {c}_{n} \vert}^{2}$$

Accordingly, it is possible to easily confirm that the light emission control method used in the display device 100 satisfies the conditions of the formula (7) or (8) by performing spectrum analysis on the luminance L(t).

While there have been described what are at present considered to be certain embodiments of the invention, it will be understood that various modifications may be made thereto, and it is intended that the appended claims cover all such modifications as fall within the true spirit and scope of the invention.

What is claimed is:

1. A driving method for a display device having a plurality of light emitting elements arranged in a matrix, wherein
one or more non-light emission periods, in which the light emitting element does not emit, are inserted in one emission cycle of the light emitting element,
in a luminance change of the light emitting element at the emission cycle of T≡2π/ω, l is a largest natural number to satisfy lω≤ωₜₕ for a given threshold frequency ωₜₕ/2π, the following holds:
$${{\sum }^{l}}_{n = 1} {\vert {c}_{n} \vert}^{2} ≦ \frac{1}{2} {\sum }_{n = 1}^{∞} {\vert {c}_{n} \vert}^{2}$$
where n is an integer and cₙ is a complex Fourier coefficient of luminance L(t) of the light emitting element in a section 0≤t<T.

2. The driving method according to claim 1, wherein
the following holds:
$${\sum }_{n = 1}^{l} {\vert {c}_{n} \vert}^{2} ≦ 0.1 {\sum }_{n = 1}^{∞} {\vert {c}_{n} \vert}^{2}$$

3. The driving method according to claim 1, wherein
the threshold frequency ωₜₕ/2π is 45 Hz or more and 120 Hz or less.

4. The driving method according to claim 1, wherein
timing for inserting the non-light emission period depends on a luminance level of the light emitting element.

5. A driving method for a display device comprising the steps of:
controlling a light emitting element of the display device to operate a light emitting cycle including k (1≤k) non-light emitting periods;
defining that the emission cycle of the light emitting element is T≡2π/ω;
defining luminance of the light emitting element in one emission cycle (0≤t<T) when the non-light emission period is not inserted is L₀(t);
defining a start time of m-th non-light emission period is tᵢₘ and an end time is t_{fm} where 1≤m≤k and 0<tᵢ₁<t_{f1}<tᵢ₂<t_{f2}< . . . <tᵢₖ<t_{fk}<T;
defining the luminance L(t) of the light emitting element in one emission cycle as:
$$L ( t ) = \{ \begin{matrix}0 , & \begin{matrix}{t}_{i 1} \leq t < {t}_{f 1} , {t}_{i 2} \leq t < {t}_{f 2} , … , \\ {t}_{ik - 1} \leq t < {t}_{fk - 1} , {t}_{fk - 1} , {t}_{ik} \leq t < {t}_{fk}\end{matrix} \\ {L}_{0} ( t ) , & otherwise\end{matrix}$$
representing L(t) by Fourier series expansion as:
$$L ( t ) = \frac{{a}_{0}}{2} + {\sum }_{n = 1}^{∞} ( {a}_{n} cos n ω t + {b}_{n} sin n ω t )$$
determining the start time tᵢₘ and the end time t_{fm} of the non-light emission period to satisfy:
$$\{ \begin{matrix}{a}_{j} < {ε}_{aj} \\ {b}_{j} < {ε}_{bj}\end{matrix} , j = 1 , 2 , … , l$$
where for a given threshold frequency ωₜₕ/2π, l is a largest natural number to satisfy lω≤ωₜₕ, j is a natural number where 1≤j≤l, and εₐⱼ and ε_{bj} are threshold values.

6. The driving method according to claim 5, wherein
εₐⱼ and ε_{bj} are defined so as to satisfy:
$${{\sum }^{l}}_{j = 1} ( {ε}_{aj}^{2} + {ε}_{bj}^{2} ) ≦ \frac{1}{2} {\sum }_{n = 1}^{∞} ( {a}_{n}^{2} + {b}_{n}^{2} )$$

7. The driving method according to claim 6, wherein
εₐⱼ and ε_{bj} are defined so as to satisfy:
$${{\sum }^{l}}_{j = 1} ( {ε}_{aj}^{2} + {ε}_{bj}^{2} ) ≦ 0.1 {\sum }_{n = 1}^{∞} ( {a}_{n}^{2} + {b}_{n}^{2} )$$

8. The driving method according to claim 5, wherein
the threshold frequency ωₜₕ/2π is 45 Hz or more and 120 Hz or less.
